(19) United States
(12) Patent Application Publication
(10) Pub. No.: US 2010/0000198 A1
(43) Pub. Date: Jan. 7, 2010

(54) GAS TURBINE WITH AT LEAST ONE MULTI-STAGE COMPRESSOR UNIT INCLUDING SEVERAL COMPRESSOR MODULES

(75) Inventor: Metin TALAN, Berlin (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: Rolls-Royce Deutschland Ltd & Co KG, Blankenfelde-Mahlow (DE)

(21) Appl. No.: 12/497,931

(22) Filed: Jul. 6, 2009

(30) Foreign Application Priority Data
Jul. 7, 2008 (DE) 10 2008 031 932.5

(51) Int. Cl. F02C 9/00

(52) U.S. Cl. 60/39.24

(57) ABSTRACT

A gas turbine includes at least one multi-stage compressor unit 2, with the compressor unit 2 including several, independent compressor modules 3-5 which, independently of each other, are rotatably borne on a drive shaft 1 and are each engageable with the drive shaft 1 by variable transmission 9-11.

This application claims priority to German Patent Application DE102008031932.5 filed Jul. 7, 2008, the entirety of which is incorporated by reference herein.

This invention relates to a gas turbine with at least one multi-stage compressor unit.

On multi-stage compressors, e.g. multi-stage high-pressure compressors of aircraft engines, all compressor stages are jointly designed for high-load conditions. However, these compressors are also required to operate at part-load or idle conditions which are characterized by significantly lower compression ratios.

The several compressor stages are jointly designed only for high compression ratios at high-load conditions and are indivisible.

Therefore, part-load or idle operation is restricted to a considerable extent.

The required low compression ratio at part load or idle is distributed to all stages. Therefore, each stage must produce a very small compression ratio. This is not achievable in operation since some stages almost reach their particular, critical surge limits, which are to be avoided, as the entire compressor and, consequently, the whole engine are put at risk.

As counter-measure, the compressor is forced to operate at higher compression ratios in part load or idle. This entails a waste of power and, for example, also fuel. Therefore, the compressor is highly uneconomical in part-load or idle operation which may amount to quite a large part of the total operating time of, for example, an engine.

A broad aspect of the present invention is to provide a gas turbine with at least one multi-stage compressor unit, which while being simply designed, ensures easy and safe operation and can be adapted to different load conditions.

In accordance with the present invention, a gas turbine with at least one multi-stage compressor unit is therefore provided in which the compressor unit is composed of several, independent compressor modules which, independently of each other, are rotatably borne on a drive shaft and are each engageable with the drive shaft 1 by way of a variable transmission. The variable transmission is provided with variably adjustable speed-increasing or speed-reducing transmission ratios, respectively. This type of transmission can, for example, be designed in the form of a chain-disk drive with setting cones or in the form of a planetary gear drive or otherwise.

According to the present invention, the transmission (as compared to other gear drives) therefore has various speed-increasing or speed-reducing ratios, respectively, thereby enabling a percentage distribution of the loads to be obtained by distinctly allotting the relative speeds between the drive shaft and the individual compressor modules. This provides for an optimization of efficiency.

According to the present invention, the compressor modules are provided with variable transmissions (with variable speed or transmission ratios, respectively). This enables the individual transmission ratios thereof to be set as required (via system control). For each of the variable transmissions, three major modes basically exist which smoothly, or continuously, transit into each other:

1. The transmission ratio can, if required, be set such that power is transmitted from the drive shaft to the compressor module. The transmission ratio can here be set such that the respective compressor module is operated at the speeds which are optimum for the compressor stages included therein. This enables the efficiency of the compressor module and, thus, of the entire compressor to be considerably increased. Altogether, this results, for example, in significant fuel saving and, consequently, improved economical efficiency of, for example, engine operation.

2. The transmission ratio can, if required, be set such that power is transmitted from the compressor module, which is driven by the airflow, to the drive shaft. At certain operating conditions this would lead to optimum distribution/utilization of the total power, which is available only to a limited extent, thereby increasing system efficiency and, thus, system economy.

3. The transmission ratio can, if required, also be set such that no power at all is transmitted (in neither direction). This corresponds to the decoupled state of this compressor module.

Each of the variable transmissions is to be set, as required, by the control unit, actually according to the direction into which power is to be transferred on the respective compressor modules (no power transfer, if applicable) and, further, according to the optimum speeds of the respective compressor modules.

The present invention is more fully described in light of the accompanying drawing showing a preferred embodiment. In the drawings,

FIG. 1 is a representation of an embodiment of a compressor unit in accordance with the present invention,

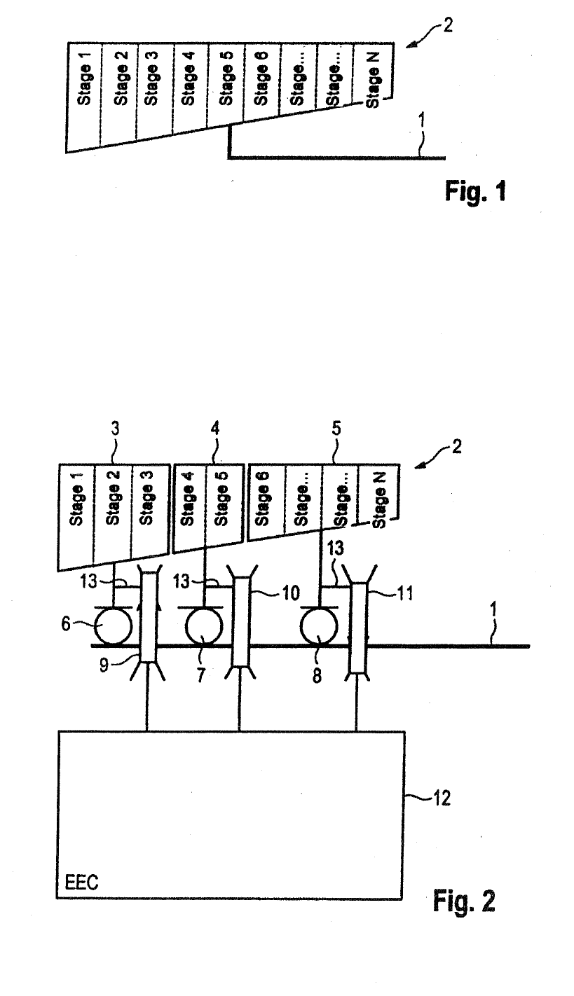

FIG. 2 is a schematic representation of an example of the compressor unit in accordance with the present invention, and

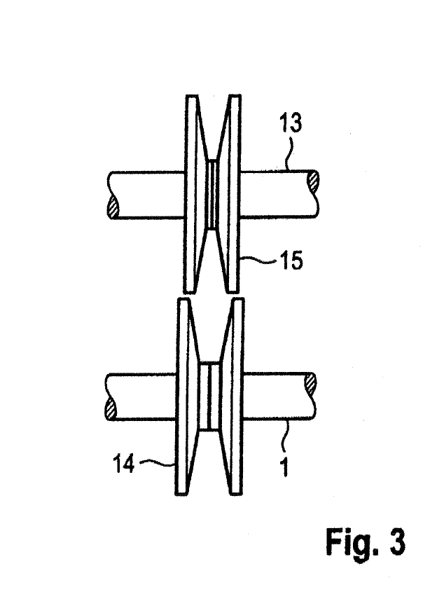

FIG. 3 is a schematic representation of an example of a variable transmission in accordance with the present invention.

The compressor unit shown in FIG. 1 includes a drive shaft 1 which, in the known manner, is rotated by a turbine or a turbine unit of a gas turbine and is fixedly connected to the individual rotors of the compressor unit 2. The compressor unit 2 includes several stages, as schematically shown in FIG. 1.

FIG. 2 conveys the subdivision of the compressor unit 2 into individual compressor modules 3, 4, 5. Each of these modules includes different compressor stages of which each, analogically to FIG. 1, has a rotor and a stator. Each rotor and each stator include at least one row of rotor blades or stator vanes, respectively, as also known from the state of the art.

FIG. 2 shows that each of the individual compressor modules 3, 4, 5 is rotatably borne on the drive shaft 1 by bearing elements or bearings 6, 7, 8, respectively. This enables the compressor modules 3, 4, 5, independently of the rotation of the drive shaft 1, to be set into rotation or have a relative speed to the drive shaft 1. The bearing arrangement is represented only schematically, it is understood that these bearings provide for both axial and radial location.

Between each of the compressor modules 3, 4, 5 and the drive shaft 1, a variable transmission 9, 10, 11 is interposed which can be actuated electrically, hydraulically, mechanically or in another manner. Actuation is by means of an EEC (electronic engine control) 12 which computes optimum speeds and optimum operating states of the individual compressor modules 3-5. Accordingly, as a first option, the variable transmission can be set to a neutral position, or a neutral gear, in which no power is transmitted between the compressor module 3-5 and the drive shaft 1 or, as a second option, the variable transmission can be set such that power is transmitted from the drive shaft to the compressor or, as a third option, the variable transmission can be set such that power is transmitted from the compressor to the drive shaft. Accordingly, by distributing the percentage power or torque transmissions, the modular compressor can be optimized. The individual compressor modules 3-5 here run at different speeds. The variable transmission can be provided as planetary gear drive or as chain-disk drive with setting cone. The latter option is exemplified in FIG. 3. Incidentally, variable transmissions are known from the state of the art, so that a detailed description can here be dispensed with.

FIG. 3 schematically shows a drive shaft 13 and a drive shaft 1 on which bevel wheel sets 14 and 15, respectively, are anti-rotationally located. The axial distance of the two bevel wheels of each bevel wheel set 14 and 15 is changeable so that a continuously circulating chain element, which is here not further detailed, is set to a radially further inward or a radially further outward position. This enables the transmission ratio to be infinitely and variably changed.

### LIST OF REFERENCE NUMERALS

1 Drive shaft
2 Compressor/compressor unit
3-5 Compressor module
6-8 Bearing/bearing unit
9-11 Variable transmission
12 EEC
13 Drive shaft
14, 15 Bevel wheel set

What is claimed is:

1. A gas turbine comprises:
a drive shaft;
at least one multi-stage compressor, the compressor unit including a plurality of independent compressor modules which, independently of each other, are rotatably borne on the drive shaft; and
a variable transmission for each independent compressor module by which the independent compressor module is engageable with the drive shaft.

2. The gas turbine of claim 1, wherein at least one variable transmission includes a variably adjustable speed-increasing transmission ratio.

3. The gas turbine of claim 2, wherein the variable transmissions can be set independently of each other.

4. The gas turbine of claim 1, wherein at least one variable transmission includes a variably adjustable speed-reducing transmission ratio.

5. The gas turbine of claim 4, wherein the variable transmissions can be set independently of each other.

6. The gas turbine of claim 2, wherein at least one variable transmission includes a variably adjustable speed-reducing transmission ratio.

7. The gas turbine of claim 6, wherein the variable transmissions can be set independently of each other.

8. The gas turbine of claim 1, wherein the variable transmissions can be set independently of each other.

9. The gas turbine of claim 1, wherein the compressor module has a compressor stage with a rotor including several rotor blades and a stator including several stator vanes.

10. The gas turbine of claim 1, wherein the compressor module has several compressor stages, each including a rotor with several rotor blades, and several stators, each of these stators including several stator vanes.

11. The gas turbine of claim 1, wherein the compressor unit is a high-pressure compressor.

12. The gas turbine of claim 1, wherein the compressor unit is a low-pressure compressor.

13. The gas turbine of claim 1, wherein the compressor unit is an intermediate-pressure compressor.
